(19) United States
(12) Patent Application Publication
(10) Pub. No.: US 2005/0048815 A1
(43) Pub. Date: Mar. 3, 2005

(54) Device for contacting in particular elongated illustratively substantially cylindrical bodies such as cables or pipes/tubes

(76) Inventor: Britta Daume, Burgwedel (DE)

Correspondence Address: SHLESINGER, ARKWRIGHT & GARVEY LLP, 1420 KING STREET, SUITE 600, ALEXANDRIA, VA, 22314, US

(21) Appl. No.: 10/950,503

(22) Filed: Sep. 28, 2004

Related U.S. Application Data
(63) Continuation of application No. 09/366,754, filed on Aug. 4, 1999, now abandoned.

(30) Foreign Application Priority Data
Aug. 6, 1998 (DE) 298 14 061.6
Aug. 14, 1998 (DE) 298 14 516.2
May 19, 1999 (EP) 99 109 828.6

(51) Int. Cl. H01R 4/66

(52) U.S. Cl. 439/98

(57) ABSTRACT

A grounding clamp for grounding the outer conductor of a coaxial cable to a grounding cable, the grounding clamp comprising a base structure comprising a clamp member adapted to be tensioned around a coaxial cable, the base structure having an interior surface, an exterior surface, an electrically conductive support element adapted to support an elastic material and an elastic material comprising at least one thermoplastic elastomer and firmly connected to the support element, elastic sealing lips integral with said elastic material and operatively associated with the base structure and extending from the interior surface of the base structure, the sealing lips providing a seal between the base structure and a coaxial cable when the base structure is tensioned around a coaxial cable, an electrical contact member operatively associated with the base structure for providing an electrically conducting connection between the outer conductor of a coaxial cable to be grounded and the grounding cable.

### CROSS-REFERENCE TO RELATED APPLICATIONS

This application is a continuation of U.S. Ser. No. 09/366,754 filed on Aug. 4, 1999 which is incorporated herein by reference.

### FIELD OF THE INVENTION

The present invention relates to a device for electrically contacting cylindrical bodies such as coaxial cables or pipes or tubes.

### BACKGROUND OF THE INVENTION

European patent document 0,744,788 A1 discloses a device for contacting, in electrically conducting manner, the electrically conducting outside surface of a cylindrical body such as a coaxial cable or a pipe. In an assembled position, the device comprises a base structure resting against the body to be contacted and consisting of an elastic metallic strap coated with an elastic rubber material.

This device is assembled in simple manner. However its manufacture is complex and hence costly.

### OBJECTS AND SUMMARY OF THE INVENTION

The objective of the present invention is to create a device free of the drawback of the prior art device. The device of the present invention is simpler and more economical.

In the present invention the elastic material is at least partly, preferably wholly, comprising at least one thermoplastic elastomer (TPE). Thermoplastic elastomers have properties similar to those of plastics and are easily processed. For example, the base structure of the present invention, to the extent it is composed of an elastic material, may be made by injection molding if using a thermoplastic elastomer. Moreover it is feasible to extrude a base structure comprising the TPE into a band. In addition to the thermoplastic elastomer, the base structure also may also comprise a elastic material such as vulcanized rubber.

Thermoplastic elastomers offer another advantage since mixing is not required immediately before processing. Instead, these materials are available in a ready-to-process state in which they may be stored.

Thermoplastic elastomers offer the special advantage in that they quickly harden and vulcanization is unnecessary. As a result, material processing is shortened. For example, if injection-molding is used, the required dwell time in the injection mold will be reduced thereby shortening the operational cycles and making the manufacture of the device of the invention more economical.

Furthermore, thermoplastic elastomers are characterized by high ageing stability. They offer the advantage of excellent permanent resistance to bending fatigue, high temperature resistance, high impact resistance, high resistance to chemicals and weathering, good electrical properties, high tear and abrasion resistance, the feasibility of co-injection molding and coextrusion with polyolefins, they are easily dyed by pigments or colorants, are recyclable and dangerous vapors such as nitrosamines are not generated during processing.

The term “contacting” in the sense of the present invention includes mechanical and/or electrical contact. In the latter case the device is fitted with a contact means to implement an electrically conducting connection between the body to be contacted and a conductor, for example a grounding cable.

The base structure of the device of the present invention may be substantially rigid. However, in a further development of the present invention, the base structure may be flexible. In this latter embodiment, the base structure has a flexibility that matches the surface of the body to be contacted. In this manner, even non-planar or curved bodies may be contacted. The bodies to be contacted may be of a variety of shapes, for example plates, bars or pipes having arbitrary cross-sections.

In another embodiment of the present invention, the base structure is such that in its assembled position it encloses the body to be contacted in the manner of a ring or bush. As a result, when contacting cables or pipes, the base structure is held reliably against the body to be contacted.

In another appropriate embodiment of the present invention, the base structure is designed as a tensioned clamp around the body to be contacted. In this embodiment, there is simplification of device assembly.

The base structure of the device of the present invention may be constructed from several parts. For example, in the case of contacting a cable or a pipe, several semi-annular parts may be consecutively mounted in the circumferential direction when in the assembled position. In a preferred embodiment, the base structure is integral and fitted at its ends with substantially perpendicular brackets that can be joined together when in a assembled position, preferably by screws or a clamp. The integral design of the base structure in this embodiment simplifies assembly of the device of the invention. By connecting the brackets to each other, the device of the invention may be fastened rapidly and simply to the body to be contacted.

In another embodiment of the present invention, elastic sealing lips are provided and mutually spaced the transverse direction or axial direction of the device and run longitudinally or circumferentially on it, and are provided at a base structure side which faces the body to be contacted when the device is in the assembled position so that when in this position, it will rest in a sealing manner against the outside surface of the body to be contacted. In this manner, a space, subtended when the device is in the assembled position, is provided between the body to be sealed and the base structure to thereby seal it against entry of air, dust or moisture. In this embodiment, the elastic material of the sealing lips are at least in part formed of a thermoplastic elastomer. As a result, the advantages offered by using a thermoplastic elastomer in manufacturing a part of the base structure also are provided in manufacturing the sealing lips.

In the above embodiments, the sealing lips may be separate or they may be joined to or integral with the base structure's elastic material. Manufacture of the device of the invention will be further simplified when the sealing lips are integral with the base structure.

In one embodiment of the present invention the thermoplastic elastomer has at least one of the following material properties:
the Shore hardness (A) is at least 35-85, preferably about 47-70, in particular about 64 (DIN 53305-A),
the compressive “set” is less than about 40%, preferably less than about 25% (DIN 53517, temperature: 70° C., time: 48 h),
the tensile strength is at least about 6 MPa (DIN 53540),
the tear elongation is at least about 300% (DIN 53504),
the cold standard is less than about −20° C., preferably less than about −40° C., in particular about −50° C. (DIN 53445-B),
the change in hardness following aging is no more than ±3 (DIN 53508, DIN 53505-A),
the change in tensile strength following aging is no more than about ±15% (DIN 53508, DIN 53504),
the change in tear elongation following aging is no more than about ±20% (DIN 53508, DIN 53504),
the thermoplastic elastomer is ozone-proof and/or uv-proof and/or oil-proof and/or weather-proof.

Each of the above material properties are advantageous, but are especially advantageous in combination, particularly regarding ease of manufacture and extended service life of the device of the invention.

In principle the base structure may consist wholly of a thermoplastic elastomer. However, in a further embodiment of the invention, the base structure is fitted with a support element to which is connected the thermoplastic elastomer. As a result, the stability of the device of the present invention is increased. The thermoplastic elastomer may be joined in a variety of manners to the support element, for example, by casting or injection molding. However it may also be in the form of an extruded band element.

In a further embodiment of the present invention, the support element is a band that runs in the longitudinal direction or in the circumferential direction of the base structure, preferably over its full length and preferably forming the brackets. This embodiment is an especially simple design that offers economy.

Regarding the embodiment containing a support element, the element is preferably metallic, and in particular, brass and/or of high-strength brass and/or low-alloy copper and/or steel alloyed with chromium-nickel. These materials provide excellent electrical conductivity and are especially advantageous when the device of the invention is a part of a fixture to set up electrical contact between an electrically conducting part such as a cable or a pipe and the support element is a current transmission element.

The device of the present invention has wide application, for example as an anode or cathode protector or to seat sensors entering a pipe through an aperture and enclosed by, for example, a bush-like device of the present invention. In one embodiment, the device of the invention may form a seal which seals external surfaces of cylindrical bodies such as pipes, hoses and cables.

In another embodiment, the device of the invention will affix an elongated, substantially cylindrical body such as a pipe or a cable. In that instance, the device forms a sealed wall-feedthrough, which may be used to mechanically affix a pipe, a hose or cable.

The present invention is also directed to a device for electrically contacting an electrically conducting part such as a pipe or cable. It comprises means to set up an electrically conducting connection between the body to be contacted and a conductor, for example a grounding cable.

In further embodiments, the contact element is metallic, preferably consisting of a flat stranded wire, a flat band, or a braided metal band. Use of such contacting elements is economical.

In other embodiments, the contacting element is connected to a support element. If the support element is metallic, an electrically conducting connection between a conductor, such as a grounding cable, and the support element, which may be externally accessible in the assembled position, may be made so that an electrical connection is established to the body to be contacted through the contacting element resting against the body.

In another embodiment of the invention, the base structure comprises at least one electrically conducting contact protrusion resting, when in the assembled position, against the electrically conducting part of the body to be contacted to thereby form a contacting means. This embodiment does not require a separate contact element and as a result, the design is further simplified.

In the above embodiment, the individual or all contact protrusions are present at the support element. If, for example, the element is constructed of sheetmetal, the contact protrusions may consist of curvatures or beads impressed in the sheetmetal.

Depending on particular requirements, the thermoplastic elastomer may be selected within a wide range of limits. For example, the thermoplastic elastomer may be a thermoplastic polyurethane (TPE-U), and/or a styrene block copolymer (TE-S) and/or a thermoplastic polyolefin elastomer (TPE-O) and/or a thermoplastic copolyester (TPE-E) and/or a polyether-polyamide block copolymer and/or an elastomer alloy of at least one thermoplastic elastomer, as provided for in the various embodiment modes.

### BRIEF DESCRIPTION OF THE DRAWINGS

FIG. 1 is a perspective view of a first embodiment of the device of the invention,

FIG. 2 is an axial cross-section on an enlarged scale of a part of an electrical cable electrically contacted by the device of FIG. 1,

FIG. 3 is a schematic perspective of the cable contacted by the device of FIG. 1,

FIG. 4 is a view similar to FIG. 2 of a second embodiment of a device of the invention,

FIG. 5 is a schematic elevation of the radial inside surface of the device of the invention of FIG. 1,

FIG. 6 is a schematic, radial section of the device of FIG. 4 in the assembled position,

FIG. 7 is a schematic perspective view of a third illustrative embodiment of a device of the invention,

FIG. 8 is a view similar to FIG. 7 of a fourth embodiment of the device of the invention,

FIG. 9 is a view similar to FIG. 7 of the device shown in FIG. 8 with one end being connected by a bracket, and

FIG. 10 is the same view as in FIG. 8 of the device of FIG. 8, the ends being connected by the two brackets.

### DETAILED DESCRIPTION OF THE PREFERRED EMBODIMENTS

Identical or corresponding components are denoted by the same references in the figures of the drawing.

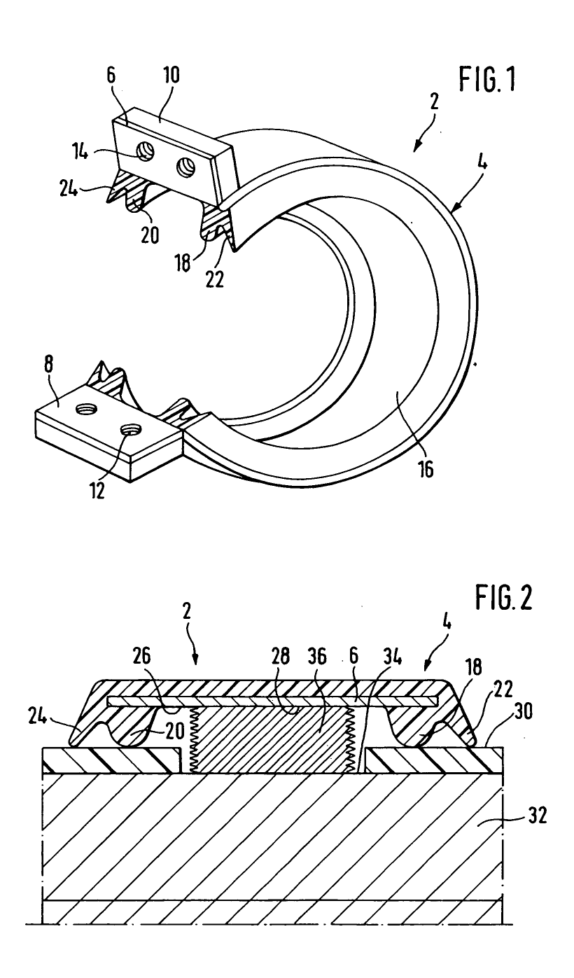

FIG. 1 shows a first embodiment of a device of the invention in the form of a device 2 contacting in an electrically conducting manner an electrically conducting part of in particular an elongated, cylindrical body such as a pipe or a cable. The device 2 comprises a flexible base structure 4 made of a thermoplastic elastomer into which is imbedded a metallic band-shaped support element 6.

The thermoplastic elastomer in this embodiment has the following material properties:
the shore hardness A is about 64 (DIN 53505-A),
the compression “set” is less than 25% approximately (DIN 53517 at 70° C., time 48 h),
the tensile strength is higher than about 6 Mpa (DIN 53504),
the tear elongation is more than about 300% (DIN 53504),
the cold standard is less than about −40° C. (DIN 53445-B),
the change in hardness following aging is no higher than about ±3 (DIN 53445-B),
the change in tensile strength following aging is no higher than about ±15% (DIN 53508, DIN 53504),
the change in tear elongation following aging is no higher than about ±20% (DIN 53508, DIN 53504), and
the thermoplastic elastomer is ozone-proof, uv proof and oil-proof.

The base structure 4 is fitted at its ends with brackets 8 and 10, the support element 6 extending in the circumferential direction of the base structure 4 as far as the region of the brackets. Through-holes are present in the bracket 8 to pass screws (not shown). When in the assembled position, the screws extend into threaded boreholes 14 formed in the bracket 10 in a manner so that by tightening of the screws, the brackets 8 and 10 can be tightened to each other and as a result, the base structure 4 encloses the body to be contacted. The screws in the threaded boreholes 14 may be used to set up an electrically conducting connection of the support element and thereby of the body to be contacted with a connecting cable (not shown), for instance a grounding cable.

The device 2 is fitted at the inside surface 16 of the base structure with mutually axially offset sealing lips 18 and 20 running in the circumferential direction of the base structure 4 and which, when in the assembly position of the device 2, rest in a sealing manner against the external surface of the body to be contacted. In this embodiment, additional sealing lips 22 and 24 are present in addition to the sealing lips 18 and 20 and axially externally to latter. In this embodiment, the sealing lips 18 and 20 and also the additional sealing lips 22 and 24 are made of the same thermoplastic elastomer as the base structure 4 and are integral with it. The device of the invention can be manufactured by imbedding the support element 6. The sealing lips 18 and 20 and the additional sealing lips 22 and 24 can also be imbedded by extrusion coating into the thermoplastic elastomer. However, the base structure 4 together with the sealing lips 18, 20, 22 and 24 may consist of extruded band material. FIG. 2 shows the thermoplastic elastomer leaves open a contact zone 28 on the inside surface 26 of the support element 6.

In the assembled position shown in FIG. 2, the device 2 together with the sealing lips 18 and 20 as well as additional sealing lips 22 and 24 rests against an external surface 30 of a substantially cylindrical body, for instance against the outside surface of a cable 32. An electrically conducting zone 34 is formed at the outside surface 30 of the cable 32 by removing the insulator of the outer conductor. A contact element 36 for setting up an electrically conducting connection between the outside surface 30 and the inside surface 26 of the support element 6, is mounted between the electrically conducting zone 34 and the inside surface 26 of the support element 6. This element in this instance being made of elastic graphite. However the contact element 36 may also be metallic, for example a metallic strand or braid.

When bracket 8 is tightened to the bracket 10 by the screws (not shown) in FIG. 1) base structure 4 is caused to enclose the outside surface 30 of the cable 32, sealing lips 18 and 20 and additional sealing lips 22 and 24 are compressed and come to rest in a sealing manner against the external surface 30 of the cable 32. A space formed between the inside surface of the base structure and the outside surface 30 of the cable 32 is caused to be sealed by the lips against penetration by dust and moisture. Moreover, seals may be provided at the brackets 8 and 10 to seal the space subtended by the inside surface 16 of the base structure 4 and the outside surface 30 of the cable 32 in the circumferential direction of the base structure.

In addition, when the brackets 8 and 10 are tightened, the contact element 36 is compressed between the inside surface 26 of the support element 6 and the electrically conducting zone 34 at the outside surface 30 of the cable 32 is created to thereby establish an electrically conducting connection between the outer conductor of the cable 32 and the support element 6. In this manner, an electrically conducting connection can be set up by means of the screws passing through the support element 6 and the threaded boreholes 14 between the outer conductor of the cable 32 and an external conductor such as a grounding cable.

FIG. 2 shows that the sealing lips 18, 20 are respectively mounted in a manner relative to the associated longitudinal edges 38 and 40 of the support element 6 of the base structure 4 so that the sealing lips 18 and 20 each run axially from a zone inside the associated longitudinal edge 38 and 40 to approximately the vicinity of the associated longitudinal edge 38, 40. In this manner, the sealing lips are reliably compressed equally when the device 2 of the invention is mounted to the cable 32 between the support element 6 and the outside surface 30 of the cable 32, rather than being individually forced out externally in an axial direction. Because the elastic material of the base structure together with the sealing lips 18 and 20 and the additional sealing lips 22 and 24 are made of a thermoplastic elastomer, the manufacture of the device 2 of the invention is economical. That is, the thermoplastic elastomer is easy to process since it may be produced by injection molding, casting or extrusion. Vulcanization is not required. Consequently, production cycles are shortened and manufacture is made more economical.

Due to the material properties of the thermoplastic elastomer, the device of the invention 2 is rugged, has long life, offers aging stability and can withstand high mechanical stresses. Furthermore, it can be used within a wide range of temperatures.

The device 2 shown in FIGS. 1 and 2 may also be used as a seal, for instance to seal an electrically conducting contact at an outer surface of a cylindrical body to prevent penetration by moisture or dust into the contacting zone. In such an application, the contacting means, in particular the metal contact element 36 and support element 6, will be unnecessary.

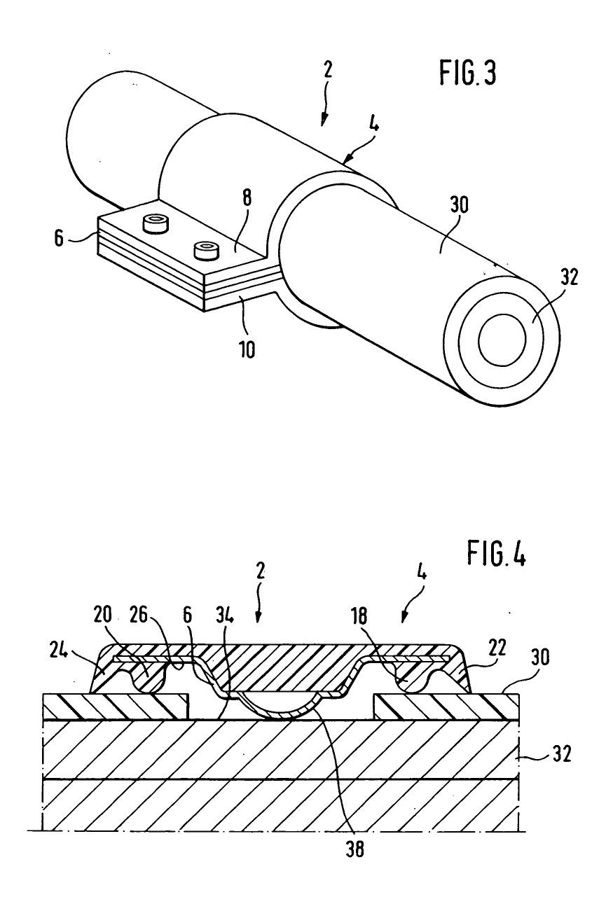

FIG. 3 shows the device 2 of FIGS. 1 and 2 in the assembled position. It is clear that the base structure 4 in this assembled position rests against the cable 32 and encloses it like a bush.

FIG. 4 shows a second embodiment of a device of the invention to set up an electrically conducting contact and differing from the embodiment of FIG. 1 in that the contact element 36 has been replaced by contact protrusions of which only one is shown and is denoted by 38 in FIG. 4. The contact protrusion 38 is formed by a substantially cross-sectionally convex bulge (relative to the cable) and when seen in a top view presents a substantially circular cross-sectional contour.

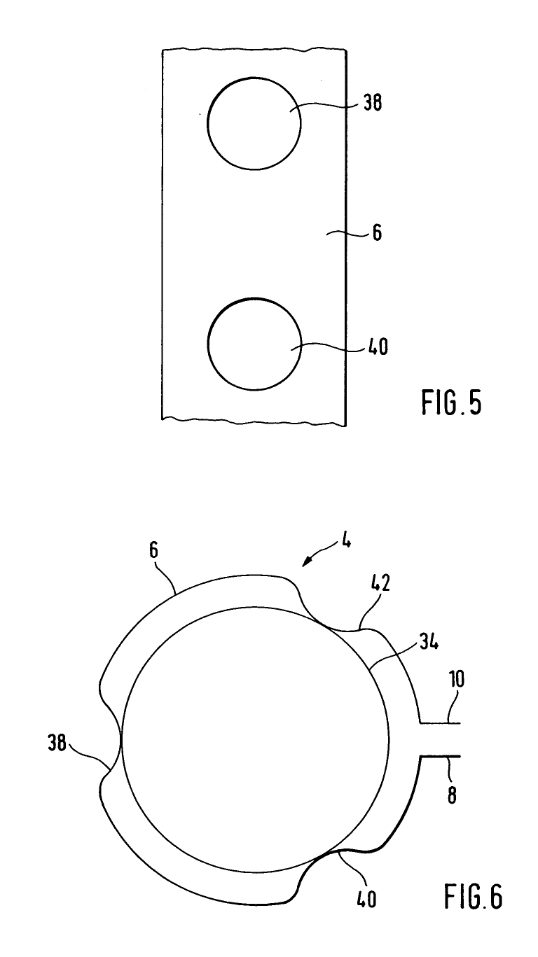

FIG. 5 is an elevation of the radial inside surface of the base structure 4 and shows that the contact protrusion 38 and a further contract protrusion 40 are each formed, in top view, in a circular profile within the support element 6.

FIG. 6 is a schematic radial section of the device 2 in the assembled position and shows, in addition to contact protrusions 38 and 40, a further contact protrusion 42. Contact protrusions 38, 40 and 42 are substantially equidistant in the circumferential direction of the base structure 4.

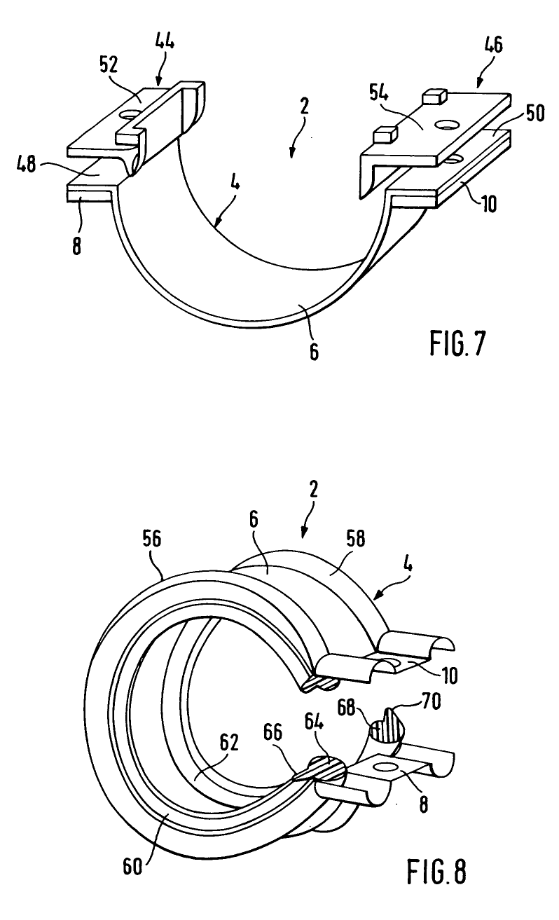

FIG. 7 is a third embodiment of a device 2 of the invention essentially differing from the embodiment of FIG. 1 in that the brackets 8 and 10 are provided with separate end parts 44 and 46 shown raised off the brackets 8 and 10 in FIG. 7. The end parts 44 and 46 in this embodiment are molded parts consisting wholly of a thermoplastic elastomer. In this embodiment, the ends 44 and 46 are over-injected on the plane surfaces 48 and 50 of the brackets 8 and 10 which in the assembled position face each other. However, they also may be connected in an arbitrary manner to the brackets 8 and 10. In the assembled position, the ends 44 and 46 comprise sealing surfaces 52 and 54 which rest against each other in a sealing manner.

FIG. 8 shows a fourth embodiment of a device of the invention 2 which differs from the embodiment of FIG. 1 in that the support element 6 is fitted with circumferential beads 56 and 58 which are disposed apart in the axial direction of the base structure 4 and which receive separate, thermoplastic-elastomer sealing-lip parts 60 and 62. The sealing-lip parts 60 and 62 may be bonded into the beads 56 and 58 or kept in them by clamping or in positively locked manner and comprise each two sealing lips 64 and 66 and 68 and 70 which are axially spaced apart.

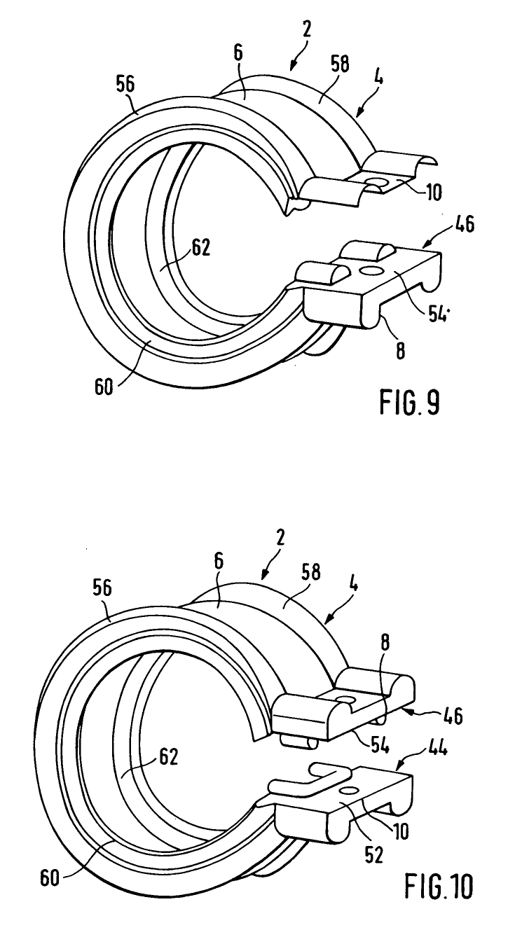

FIG. 9 shows the device 2 of FIG. 8 where the bracket 8 connects the end part 46. To preclude leaks in a region where the sealing-lip parts 60 and 62 adjoin the sealing surface 54, the end part 46 may be fitted with recesses complementary with the free ends of the adjoining sealing-lip parts 60 and 62 and receiving the latter. However, the end part 46 may also be joined to the ends of the sealing-lip parts 60 and 62, for instance by over-injecting.

FIG. 10 shows the device of FIG. 9, the end 44 being connected to the support element 6 in a manner corresponding to the end part 46. In the embodiment of FIGS. 8 through 10, the sealing-lip parts 60 and 62 are preferably are made of the same thermoplastic elastomer as the end parts 44 and 46.

Furthermore the sealing-lip parts 60 and 62 also may be integral with the end parts 44 and 46 and/or the end parts 44 and 46 illustratively may be injected over the support element 6.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. A grounding clamp for grounding the outer conductor of a coaxial cable to an electrical ground device, said grounding clamp comprising:
a) a base structure adapted to be tensioned around a coaxial cable in the manner of a clamp, said base structure having an interior surface, an exterior surface and an electrically conductive support element firmly connected thereto, said base structure is formed from an elastic material;
b) elastic sealing lips formed from said elastic material and integral with said base structure, said elastic sealing lips extending from said base structure interior surface, said sealing lips for providing a seal between said base structure and a coaxial cable when said base structure is tensioned therearound;
c) an electrical contact member, said electrical contact member operatively associated with said base structure for providing an electrically conducting connection between the outer conductor of a coaxial cable to be grounded and the electrical ground device;
d) said elastic material comprising at least one thermoplastic elastomer having at least one physical property selected from the group consisting of a shore hardness A between about 35 to about 85 A, a compression set less than about 40%, a tensile strength higher than about 6 Mpa, a tear elongation higher than about 300%, a cold standard lower than about −20 degrees Celsius, a change in shore hardness over time that does not exceed about 3 A, a change in tensile strength over time no larger than about 15%, and a change in tear elongation over time no higher than about 20%.

2. A grounding clamp as in claim 1 and wherein said base structure is flexible.

3. A grounding clamp as in claim 1 and wherein said base structure is adapted to enclose the coaxial cable in an annular manner when tensioned therearound.

4. A grounding clamp as in claim 1 and further including:
a) cooperating orthogonal bracket members, said bracket members operatively associated with said base member and adapted to be interconnected by at least one of screws or clamps.

5. A grounding clamp as in claim 4 and wherein said support element comprises a band extending at least partially into said base structure and forming said cooperating orthogonal bracket members.

6. A grounding clamp as in claim 1 and wherein said support element is constructed from at least one metal selected from the group consisting of high-strength brass, low-alloy copper and steel alloyed with chromium-nickel.

7. A grounding clamp as in claim 1 and wherein said electrical contact member comprises a contact element mounted to said base structure interior surface so that when said grounding clamp is in an assembled position with the coaxial cable, it faces the coaxial cable.

8. A grounding clamp as in claim 7 and wherein said electrical contact member is metallic.

9. A grounding clamp as in claim 8 and wherein said electrical contact member is at least one of a flat strand, flat band or braided band.

10. A grounding clamp as in claim 8 and wherein said electrical contact member is connected to said support element.

11. A grounding clamp as in claim 1 and wherein said electrical contact member includes at least one contact protrusion constructed from an electrically conducting material so that when said grounding clamp is in an assembled position with the coaxial cable, said least one contact protrusion constructed from an electrically conducting material will provide electrical contact thereto.

12. A grounding clamp as in claim 11 and wherein said at least one contact protrusion constructed from an electrically conducting material is formed on said support element.

13. A grounding clamp as in claim 1 and wherein said at least one thermoplastic elastomer is selected from the group consisting of thermoplastic polyurethane, styrene block copolymer, thermoplastic polyolefin elastomer, polyether-polyamide block copolymer, thermoplastic copolyester and combinations thereof.

14. A grounding clamp as in claim 1 and wherein said shore hardness is between about 47 to about 70 A.

15. A grounding clamp as in claim 1 and wherein said shore hardness is about 64 A.

16. A grounding clamp as in claim 1 and wherein said compression set is less than about 25%.

17. A grounding clamp as in claim 1 and wherein said cold standard is lower than about −40 degrees Celsius.

18. A grounding clamp as in claim 1 and wherein said cold standard is lower than about −50 degrees Celsius.

19. A grounding clamp as in claim 1 and wherein said contact member is connected to said support element.
